(19) United States
(12) Patent Application Publication
(10) Pub. No.: US 2004/0145784 A1
(43) Pub. Date: Jul. 29, 2004

(54) Scanner apparatus with field segmentation and method of operating the same

(76) Inventors: David K. Murray, Lexington, KY (US); Angela C. Schanding, Winchester, KY (US); Brent A. Schanding, Winchester, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/352,673

(22) Filed: Jan. 28, 2003

(51) Int. Cl. H04N 1/04; H04N 1/46

(52) U.S. Cl. 358/474; 358/505

(57) ABSTRACT

Scanner apparatus include a scanner having a scanbed that is positioned to place an object to be scanned in a scan field of the scanner. A configurable field segmentor is positioned adjacent the scanbed that demarcates a plurality of fields within the scan field. The field segmentor may be one or more scan guides configured for placement in one of a plurality of demarcation locations adjacent the scanbed. Alternatively, the field segmentor may be one or more templates configured for placement adjacent the scanbed.

### BACKGROUND OF THE INVENTION

The present invention relates to scanner apparatus and, more particularly, to scanner apparatus for media, such as photographs.

Scanners are now commonly used to create digital images from a variety of media, such as photographs. For example, many photography retail outlets make scanners available for customer use in creating digital images from the customer's photographs and may even provide decorative frames that can be positioned around a photograph before scanning.

In some cases, it may be desirable to scan multiple items and/or items of varying sizes at the same time on a scanner. Scanning of multiple items or items of varying sizes may result in skewed images. There is typically only one reference point on a scanbed of a scanner to orient and position media before scanning. One approach to avoid this problem is to scan each of the images one at a time, but such an approach may be time consuming for the user. In addition, copying images one at a time where it is desired to generate multiple images for printing on one sheet may use a software program to combine the separate images before printing on a single sheet. Thus, a need exists for improved methods and apparatus for scanning multiple images concurrently.

### SUMMARY OF THE INVENTION

Embodiments of the present invention provide scanner apparatus including a scanner having a scanbed that is positioned to place an object to be scanned in a scan field of the scanner. A configurable field segmentor is positioned adjacent the scanbed that demarcates a plurality of fields within the scan field.

In some embodiments of the present invention, the field segmentor is one or more scan guides configured for placement in one of a plurality of demarcation locations adjacent the scanbed. The scan guide(s) may include a locating member at an end thereof and the scanner apparatus may include a mating member in the scanner adjacent the scanbed configured to receive the locating member and position the scan guide(s) in one of the demarcation locations. The locating member may be a channel in an end portion of the scan guide(s) and the mating member may be an engaging member configured to mate with the channel. Alternatively, the mating member may be one or more channels and the locating member may be an end portion of the scan guide(s) configured to mate with the channel(s).

In other embodiments of the present invention, the channel(s) are a plurality of pairs of channels positioned in the scanner to provide at least one of the plurality of fields with a size corresponding to a common photo size. The common photo size may be selected from a group consisting of 2 inches by 3 inches, 3 inches by 5 inches, 4 inches x 6 inches, 6 inches by 9 inches, 8 inches by 10 inches and 9 inches by 12 inches.

In further embodiments of the present invention, the demarcation locations are at least one pair of grooves. The grooves of a pair of grooves are positioned in the scanner on opposite sides of the scan field. The scan guide(s) have a length selected to extend between the at least one pair of grooves. The scan guide(s) have opposite end portions configured to be received within the grooves of a pair of grooves. The scan guide(s) may have a length selected to extend across either the length or the width of the scan field. A plurality of scan guides may be provided where some have a length corresponding to the width and some to the length of the scan field.

In other embodiments of the present invention, the demarcation locations are a plurality of pairs of grooves, the grooves of a pair of grooves being positioned in the housing on opposite sides of the scan field across the length of the scan field. At least one of the scan guides has a length selected to extend between a pair of grooves and at least one of the scan guides has opposite end portions configured to be received within the grooves of a pair of grooves. At least one other of the scan guides may have a length selected to extend across the width of the scan field. The at least one other of the scan guides may be configured to slide along the scan field above the scan guides positioned in the plurality of grooves. The plurality of pairs of grooves may be positioned in the housing to provide at least one of the plurality of fields with a size corresponding to a common photo size.

In further embodiments of the present invention, the scan guide(s) include a substantially straight alignment edge. The scan guide(s) may include two substantially straight alignment edges each having a different associated scale, for example, English and metric units. The scanner may further include a cover rotatably connected to the scanner and having a closed position covering the scanbed. The cover may include one or more pockets configured to receive the scan guide(s) for storage.

In other embodiments of the present invention, the scan guide(s) further include an identification marking that is positioned to be detected by the scanner when the scan guide(s) are positioned in the scan field. The scanner may be configured to embed position information based on detection of the identification marking in scan data provided to a processor coupled to the scanner. The processor may be configured to demarcate the scan data into separate images corresponding to ones of the plurality of fields based on the embedded position information.

In further embodiments of the present invention, the field segmentor includes one or more templates configured for placement adjacent the scanbed. The template(s) may include a plurality of substantially straight alignment edges configured to align media in respective ones of the plurality of fields. The template(s) may also include separation regions between ones of the plurality of fields to demarcate the scan field into a plurality of offset fields. The separation regions may include a decorative border pattern positioned facing the scan bed. The decorative border pattern may be, for example, a sport, holiday or birthday pattern. The template(s) may include a plurality of templates having different associated field patterns to provide different desired shapes to the plurality of fields. The template(s) may define fields within the scan field having sizes corresponding to common photo sizes.

In other embodiments of the present invention, the template(s) further include an identification marking that is positioned to be detected by the scanner when the template(s) are positioned in the scan field. The scanner may be configured to embed template identification information based on detection of the identification marking in scan data provided to a processor coupled to the scanner. The scanner apparatus may further include a processor configured to demarcate the scan data into separate images corresponding to the plurality of fields based on the embed template identification information. The processor may be configured to demarcate the scan data into separate images based on a stored template map corresponding to the embedded template identification information. The scanner may include a processor configured to detect ones of the plurality of fields based on a white space pattern in scan data.

In yet further embodiments of the present invention, methods are provided for scanning multiple media into separate images. A configurable field segmentor is positioned adjacent a scanbed of a scanner to demarcate a plurality of fields within a scan field defined by the scanbed. Media is positioned in ones of the plurality of fields. The scan field is then scanned to provide scan data. The plurality of fields is detected based on the scan data and separate images are generated from the scan data for ones of the detected plurality of fields.

In some embodiments of the present invention, positioning a configurable field segmentor includes selecting a template having desired fields from a plurality of different templates. The selected template is placed adjacent the scan bed. Detecting the plurality of fields may include detecting template identifier information in the scan data.

In other embodiments of the present invention, positioning a configurable field segmentor includes positioning at least one length demarcating scan guide at a selected demarcation location adjacent the scan bed. At least one width demarcating scan guide may be placed at a selected demarcation location adjacent the scan bed, the at least one width demarcating scan guide extending substantially orthogonally to the at least one length demarcating scan guide. Detecting the plurality of fields may include detecting position information indicating the selected demarcation locations of the scan guides in the scan data and determining the field boundaries based on the demarcation locations of the scan guides.

In further embodiments of the present invention, scanner configuration devices for a scanner having a scanbed that is positioned to place an object to be scanned in a scan field of the scanner are provided. The configuration device includes a configurable field segmentor configured to be positioned adjacent the scanbed and demarcate a plurality of fields within the scan field. The field segmentor may be one or more scan guides configured for placement in one of a plurality of demarcation locations adjacent the scanbed. In other embodiments, the field segmentor is one or more templates configured for placement adjacent the scanbed.

### BRIEF DESCRIPTION OF THE DRAWINGS

FIG. 1 is a perspective view illustrating a scanner apparatus according to some embodiments of the present invention;

FIG. 2 is an exploded perspective view of the scanner apparatus of FIG. 1 according to embodiments of the present invention;

FIG. 3 is a cross-sectional view of a scan guide pocket according to some embodiments of the present invention;

FIG. 4 is a perspective view illustrating a scanner apparatus according to further embodiments of the present invention;

FIG. 5 is a perspective view illustrating a scanner apparatus according to further embodiments of the present invention;

FIG. 6 is an exploded perspective view of a scanner apparatus according to other embodiments of the present invention; and

FIG. 7 is a flowchart illustrating methods for scanning multiple media into separate images according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention is described below with reference to flowchart illustrations and/or block and/or flow diagrams of scanning methods and scanner apparatus according to some embodiments of the invention. It will be understood that each block of the flowchart illustrations can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

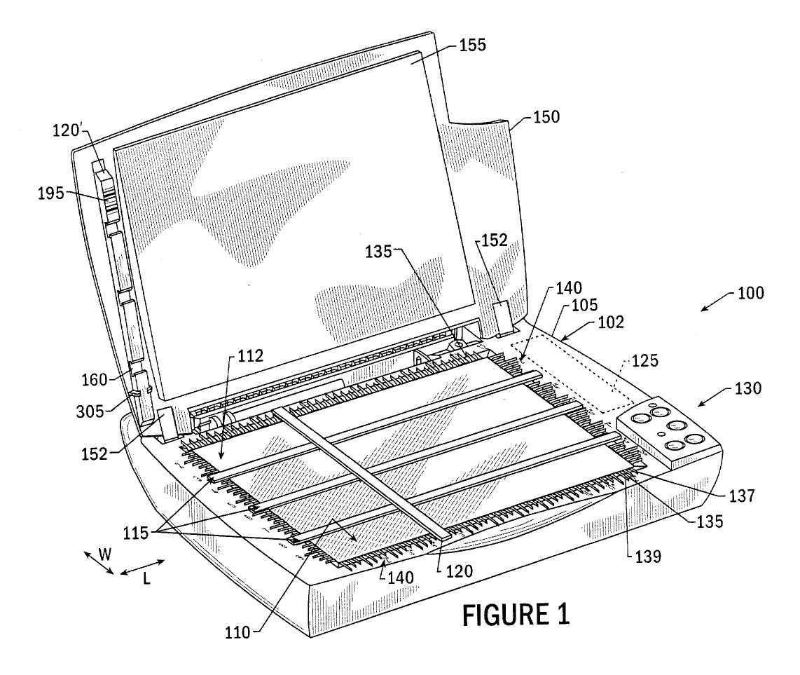

Embodiments of the present invention will now be described with reference to the various embodiments illustrated in FIGS. 1-7. FIG. 1 is a perspective view that illustrates some embodiments of scanner apparatus according to the present invention including scan guides. As shown in the embodiments of FIG. 1, the scanner apparatus 100 includes a scanner 102 and a configurable field segmentor including scan guides 115 and a scan guide 120, which is oriented orthogonally to the scan guides 115.

The scanner 102 includes a housing 105 and a cover 150 rotatably connected to the housing 105 by a hinge 152. A scanbed 110 positioned on the upper surface of the housing 105 provides a region on which an object to be scanned may be placed in a scan field 112 of the scanner 102. The scan guides 115, 120 are positioned adjacent the scanbed 110 to demarcate a plurality of fields within the scan field 112 of the scanner 102. The scanner 102 further includes a scan circuit 125 that provides electrical circuitry for processing scanned data and may further include various mechanical components and drive mechanisms related to moving optical detector devices across the scan field 112 to generate corresponding scan data from objects placed on the scanbed 110. A control panel 130 may be provided to facilitate operator input for operation of the scanner 102.

For purposes of explanation of the scanner apparatus 100, a length axis (L) extending across the scanbed from left to right in FIG. 1 and a width axis (W) extending across the scanbed 110 from top to bottom are illustrated in FIG. 1. Pairs of channels or grooves 135, 135′ in the scanner 102 adjacent the scanbed 110 provide a mating member configured to receive respective opposite ends of the scan guides 115, 120. More particularly, the scan guides 115, 120 have opposite end portions configured to provide a locating member for positioning in the mating member 135, 135′ of the scanner 102. Respective demarcation locations can thereby be defined in both the width and length direction of the scanbed 110 for flexible configuration of the field demarcations within the scan field 112 of the scanner 102. In further embodiments, only one channel or groove may be used rather than pairs.

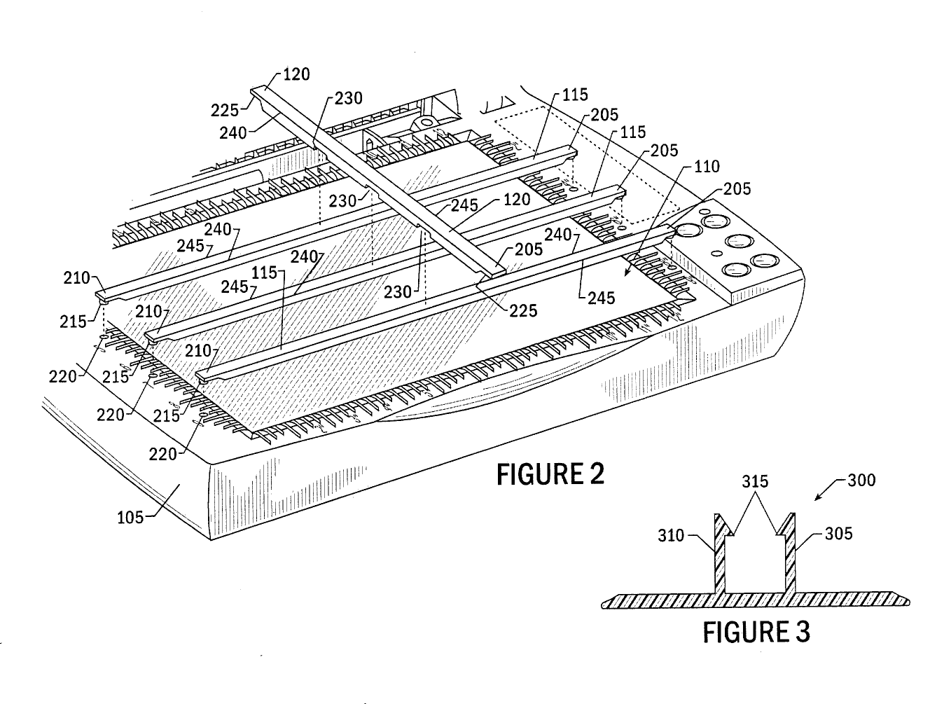

As best seen in the exploded perspective view of FIG. 2, the locating member and mating member may respectively be a hole 220 and a corresponding tab 215 configured to mate with the hole 220 to position the scan guides 115. As more particularly shown in FIG. 2, the tabs 215 are positioned on the ends of the scan guides 115 and the holes 220 are located in the housing 105 of the scanner 102. However, it is to be understood that the channel/hole may be located in the scan guides and the corresponding mating feature, such as a tab, may be positioned in the scanner 102 in various other embodiments of the present invention. In addition, multiple locating/mating features may be used in combination.

Different demarcation points provided by the mating members 135, 135′ along the width and length of the scanbed 110 may be selected to provide fields corresponding to common photo sizes. Exemplary photo sizes include 2 inches by 3 inches, 3 inches by 5 inches, 4 inches by 6 inches, 6 inches by 9 inches; 8 inches by 10 inches and 9 inches by 12 inches as well as other generally known photo sizes depending on the size of the scanbed 110. Furthermore, scaling information, such as numeric values 140, may be located within the channel/grooves 135, 135′ to aid in positioning the scan guides 115, 120. Furthermore, a metric scale may be used in addition to or instead of an English scale to provide the ability to select demarcation locations based on different coordinate scales.

As shown in the embodiments of FIGS. 1 and 2, the scan guides 115 may differ from the scan guide 120 in length and in method of positioning. The scan guides 115 have a length selected to extend across the length (L) of the scan field provided by the scanbed 110 while the scan guide 120 has a length selected to extend across the width (W). Furthermore, for the particular embodiments as best illustrated in FIG. 2, the scan guide 120 is configured to slide along the scan field above the scan guides 115 positioned in the respective grooves and locating holes of the scanner housing 105. More particularly, as shown in FIG. 2, the scan guide 120 includes channels 230 at offset locations therein configured to mate with and slide along the underlying scan guides 115. As also shown in FIG. 2, the scan guides 120 include opposite end portions 205, 210 having a downward facing faces 225 configured to slide along the scanner housing 105. Both the scan guides 115 and the scan guide 120 each may have substantially straight alignment edges 240, 245 configured to align media in respective ones of the plurality of fields to orient the media with the scan guides are positioned in the scanbeds 110.

Referring again to FIG. 1, the scanner apparatus 100 as illustrated includes an additional width type scan guide 120′ positioned in a holding pocket 160 positioned on the cover 150. The particular holding pocket shown in FIG. 1 is further illustrated in the cross-sectional diagram of FIG. 3 as a retaining clip assembly 300. The clip assembly 300 includes a first arm 305 and an associated second arm 310, each of which has an inward extending engaging portion 315 with sloped faces directed towards the opening between the arms 305, 310. A scan guide 115, 120 may thereby be snapped into the assembly 300 when not in use. While a clip type assembly 300 is shown in FIG. 1 and FIG. 3, it is to be understood that different types of pocket, such as a conventional pocket with extending sides and a closed bottom may also be used in accordance with the present invention. Furthermore, while only one pocket 160 is illustrated in FIG. 1, additional storage locations may be provided, for example, on the other edges extending around the scanbed cover surface 155. The pockets could also be located in the housing 105 in addition to or rather than being located in the cover 150 of the scanner 102.

While the cover 150 is shown in FIG. 1 as rotatably connected by a hinge 152, the cover may be connected by other means or may be a separate member with guide means to provide placement of the background surface 155 over the scanbed 110 for scanning. As also shown in FIG. 1, the grooves or channels 135 may be provided by paired walls 135, 137 extending up from the upper surface of the housing 105 adjacent the scanbed 110.

In addition to different lengths for the scan guides 115 and 120, the respective length and width scan guides may also be distinguished by different colors. For example, one set of scan guides may be blue while the others may be red. Furthermore, while FIG. 2 illustrates embodiments in which one of the directions of scan guides is slideable along the other, it is to be understood that both scan guide sets may be fixidly mountable adjacent the scanbed 110 so as to provide field size, aligning edges and/or separation between different media positioned for scanning on the scan bed 110. Furthermore, both orientations of scan guides may be slidable. In addition, the removable scan guides may include a tether or other means to reduce the risk of loss and/or a storage pocket as described above.

The alignment edges 240, 245 may include respective scales to aid in placement of the scan guides at the desired sizes and a different scaling unit may be used for respective alignment edges to show both English and/or metric units. Thus, unit scaling may be provided either on the upper surface of the scanner housing 105, on the scan guides 115, 120 and/or on both.

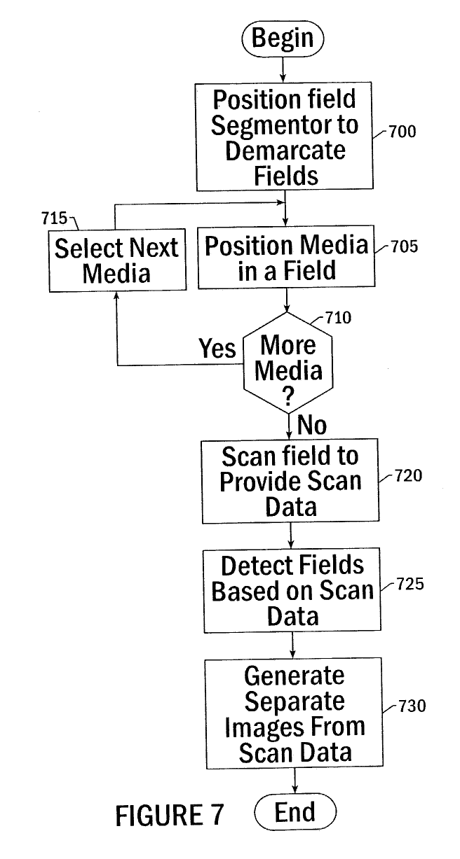

Each of the scan guides 115, 120 may include an identifier 195 (FIG. 1) positioned on a surface of the scan guides 115, 120 facing the scan bed 110. The identifier 195 may be, for example, a bar code. The identifier 195 may be detected by the scanner 102 when the scan guides 115, 120 are positioned in the scan field and scanned data is obtained. As will be described more fully later with respect to the flow chart diagram of FIG. 7, the scanner 102 may be configured to embed position information based on detection of the identification marking in scan data provided to a processor coupled to the scanner (either included in the scanner apparatus or by a cable/wireless connection). The processor may be configured to demarcate the scanned data into separate images corresponding to ones of the fields based on the embedded position information.

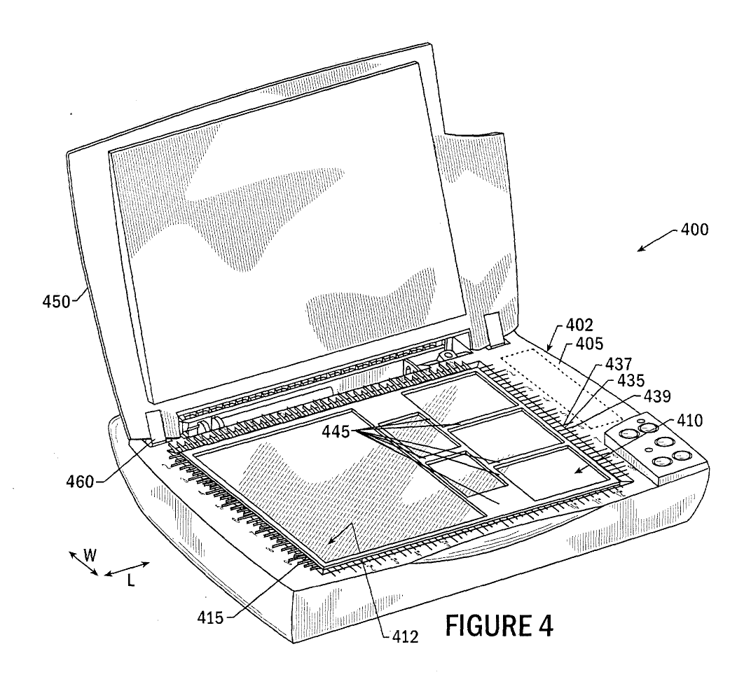

Further embodiments of a scanner apparatus according to the present invention will now be described with reference to FIGS. 4-6. For the embodiments illustrated in FIGS. 4-6, the configurable field segmentor is one or more templates configured for placement adjacent the scanbed. As will be understood from the description, the templates may serve to provide straight edge(s) for aligning media and to separate media from each other in the scan field by a desired amount. The templates can be substantially any size and shape, although common photo sizes may be desirable for use in designing appropriate templates. In addition, the templates themselves may be used to crop media, such as photos, to desired sizes or shapes and may further be used as a mat around the media or photos. In particular embodiments, the templates could provide additional features, such as providing patterns (which may be colored patterns) facing the scanbed 110 so that the patterns may be detected and included in the scan data so as to serve as mats or frames similar to the frame option sometimes found at retail photo shops. Suitable patterns could include patterns such as birthday, holiday or sport patterns but are not limited solely to these particular patterns. Also, as described for the scan guides above, the templates may contain unique identifiers that may be detected by the scanner in scan data obtained while the templates are positioned on the scanbed so that the scanner (or host processor device coupled to the scanner) may recognize a template and split a picture into separate files based on knowledge of the template.

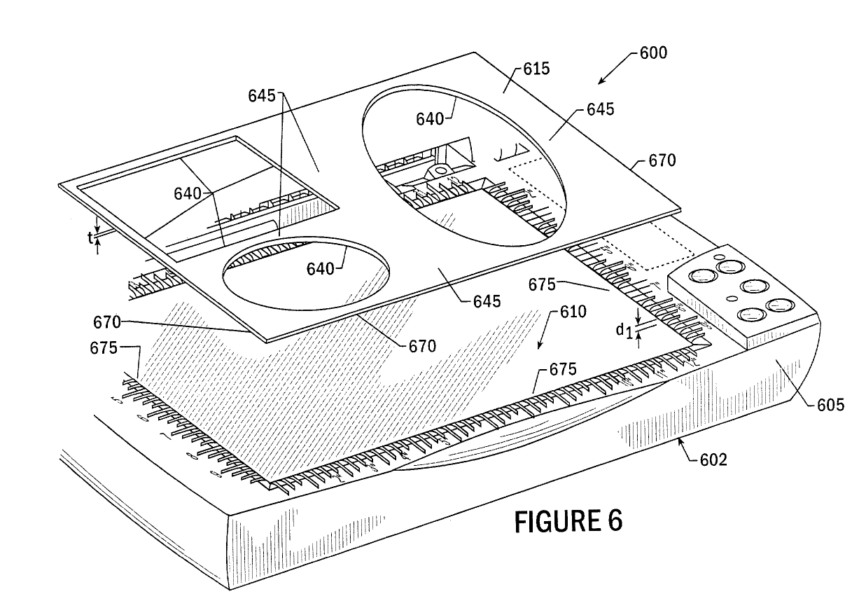

As shown for the embodiments illustrated in FIG. 4, the scanner apparatus 400 includes a scanner 402 and a template 415 providing a configurable field segmentor. The template 415 is positioned adjacent a scanbed 410 to demarcate a plurality of fields within a scan field 412 of the scanner 402 provided by the scanbed 410. A scaling system similar to that described with reference to the grooves 135, 135′ and numbering 140 of FIG. 1 may be positioned around the scanbed 410 in a housing 405 of the scanner 402. The sidewalls 437, 439 may be used merely for demarcation of the groove regions 435 for defining relative locations and need not be used as part of a locating mechanism for positioning the template 415 adjacent the scanbed 410 as the template 415 may be scaled to conform with the size of the scanbed 410 and have external straight edges configured to align with an alignment edge of the scanbed 410 as will be further described with reference to FIG. 6. The embodiments of the scanner apparatus 400 shown in FIG. 4 further include a cover 45° rotatably connected to the housing 405 by a hinge 460.

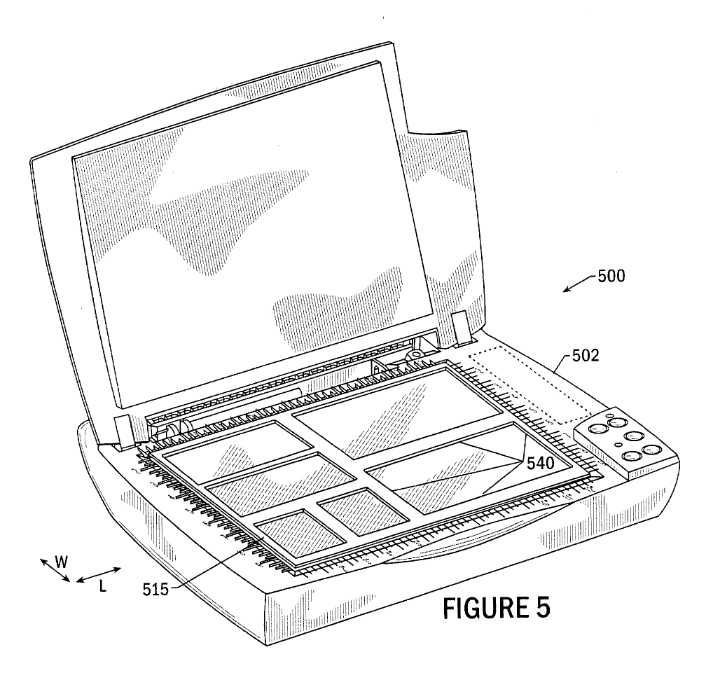

As described above, different template patterns may be used to provide flexibility in configuration of the field segmentation in the scan field of the scanner 402. An exemplary further template 515 is illustrated in FIG. 5. The scanner apparatus 500 of FIG. 5 is otherwise substantially identical to that of FIG. 4. As shown in FIG. 4 and FIG. 5, the templates 415, 515 may support a variety of different field sizes, spacing between fields and relative positioning of different fields. The templates 415, 515 may also include different numbers of fields in the template pattern.

As further shown in FIG. 5, each of the demarcated fields may be defined by one or more substantially straight alignment edges 540. The alignment edges 540 may be used to align and space media in the different fields. As more clearly shown in FIG. 4, the templates 415, 515 further may include separation regions 445 between ones of the plurality of fields to demarcate the scan field into offset fields. The decorative border patterns described above may be positioned on a surface of the separation regions facing the scanbed 410. An identification marking, such as a bar code, may also be placed in the separation regions 445 and/or around the outer edge regions of the template 415 and positioned in the scan field of the scanner 402 so as to be detected by the scanner 402. Such an identifier may be used in a manner substantially as described above with reference to the embodiments of FIGS. 1 and 2. In the case of the template 415, 515, the demarcation based on such an identification may, for example, be based on a stored template map retained by the scanner 402 and/or other processor coupled to the scanner 402 corresponding to the template identification information.

Template based field segmentors will now be further described with reference to the exploded perspective view of FIG. 6. As shown in FIG. 6, the scanner apparatus 600 includes a scanner 602 having a housing 605 and a cover 650. A scanbed 610 is located on an upper surface of the housing 605. The scanbed 610 includes respective alignment edges 675 extending along a length and/or width of the scanbed 610. The alignment edges are sunken a respective distance d1 into the housing 605 to provide a vertically extending reference surface for positioning of the template 615. The template 615 includes corresponding edge(s) 670 configured to matingly align with the alignment edge(s) 675 of the scanbed 610 so as to position the template 615 in the proper location and/or with the proper orientation in the scanbed 610. The edge(s) 670 have a thickness (t) suitable for alignment with the alignment edge(s) 675 of the scanbed 610. The template 615 may also include a tether or other connecting means to reduce the risk of loss of the template.

The exemplary template 615 shown in FIG. 6 differs from the templates 415 and 515 in that only three fields are demarcated by the template 615. Furthermore, the alignment edges 640 of the template 615 are only substantially straight in one of the three fields, while the remaining fields provide, respectively, a circular and oval shape. The template 615 may, thus, be used, for example, to provide a mat pattern with respective distinct media positioned in the different fields. Similarly, a decorative pattern may be provided in the separation region 645 between the respective fields. While the templates 415, 515, 615 all illustrate embodiments in which the overall size of the templates is selected to match with the total area of the scanbed 410, 510, 610, it is to be understood that, in various embodiments of the present invention the scanbed may be larger or smaller than the templates and that all four external edges of the templates need not provide alignment, as alignment may be provided along two edges or, in various embodiments along a single edge 675 of the scanbed 610.

Operations related to scanning multiple media into separate images according to embodiments of the present invention will now be described with reference to the flow chart illustration of FIG. 7. As shown in FIG. 7, operations begin by positioning a configurable field segmentor adjacent a scanbed of a scanner to demarcate a plurality of fields within a scan field of the scanner (Block 700). The configurable field segmentor may be scan guides and/or templates as described above. A media, such as a photograph, is positioned on a selected one of the demarcated fields (Block 705). If more media remains to be positioned in fields of the field segmentor (Block 710), a next media is selected (Block 715) and positioned in a selected field (Block 705). Once all the selected media is positioned (Block 710), the scan field is scanned to provide scanned data (Block 720). The plurality of fields is detected based on the scan data (Block 725). Separate images are then generated from the scanned data for ones of the detected plurality of fields (Block 730). These separate images may be, for example, stored, manipulated, displayed, etc. separately.

It is to be understood that operations related to positioning of the configurable field segmentor at Block 700 may include selecting a template having desired fields from a plurality of different templates and placing the selected template adjacent the scanbed. Alternatively, positioning operations at Block 700 may include positioning one or more length demarcating scan guides at selected demarcation locations adjacent the scanbed and may further include positioning width demarcating scan guides at selected demarcation locations adjacent the scanbed where the width scan guides extend substantially orthogonally to the length demarcating scan guides. In addition, a combination of scan guides and templates to define fields within a field demarcated by the scan guides may be used. It is further to be understood that the plurality of fields may be detected by detecting an identifier, such as a template identifier, in the scanned data. Alternatively, position information indicating the selected demarcation location for scan guides may be detected in the scanned data and the field boundaries may be determined based on the demarcation locations of the scan guides.

It is to be understood that the scanner apparatus described above in accordance with various embodiments of the present invention may be utilized with a variety of different methods for detecting the boundaries of the respective multiple images defined by the plurality of demarcated fields. As noted above, one approach is to provide scan guides with markings on the scan guides that may be detected and recognized by the scanner. The marking will thereby identify the position of the respective scan guides on the scanbed. In particular embodiments, the marking used is a unique pattern that will not or is unlikely to naturally occur in any normal scanned image from media positioned in the various fields to reduce the risk of a false detection of the scan guide position. Once the scanner hardware/software recognizes the identification marker, this information may be embedded in scanned data to be subsequently processed by the scanner or by a host processor device coupled to the scanner, such as a personal computer. The host may then receive the embedded information along with the image scanned data and calculate the intersections of the scan guides to break the scanned data imagery up into several distinct images based on where the scan guides are placed.

A similar approach may be utilized with respect to embodiments using templates as field segmentors. The templates positioned on the scanbed have a known set of image boundaries defining the demarcated fields. Again, the templates may be provided a unique pattern to identify which template is positioned in the scanbed at the time of scanning. The scanner hardware/software may then recognize the unique identification pattern and embed such information in scanned data that will be subsequently processed, either by the scanner or by a host device such as a personal computer coupled to the scanner. The host device may recognize the template that has been placed on the scanner and break the image up into several distinct images matching known boundaries for the template. For example, the scanner or host device may be provided template pattern data associated with the different unique identifiers.

While each of these described approaches relies on identification information from the configurable field segmentor, additional approaches may be utilized for detection of the respective demarcated field regions. For example, it is known to use edge detection algorithms for finding edges in scanned data. Thus, an edge detection methodology may be used to find image boundaries, for example, based on “white space” that is present in the scanned image. When a white space pattern is detected that continues, for example, across the whole imagine being scanned or that has definite intersections with other white space areas, hardware/software may be provided to demarcate the image into distinct fields based on the pattern found in the white space analysis. To further reduce the risk for erroneous detection of demarcations, certain expected white space patterns may be identified and searched for by the hardware/software to facilitate correct detection of image boundaries. The white space analysis may be based on finding white space parallel to the horizontal or vertical access of the received scanned data that either extends completely across an image or intersects with an orthogonal white space region that was also detected. Accordingly, it is to be understood that a variety of different methods of field detection from the scanned data may be utilized with the various scanner apparatus embodiments provided by the present invention. It is also to be understood that the scanner apparatus or host device connected thereto may provide for cropping of the scanned data and presenting the images to a user with undesired information removed from the displayed images.

The flowchart of FIG. 7 illustrates the architecture, functionality, and operation of possible implementations of methods for scanning multiple media into separate images. In this regard, each block in the flowchart may represent a module, segment, or portion of code, which comprises one or more executable instructions for implementing the specified logical act(s). It should also be noted that, in some alternative implementations, the acts noted in the blocks may occur out of the order noted in the figures. For example, two blocks shown in succession may, in fact, be executed substantially concurrently, or the blocks may be executed in the reverse order, depending upon the functionality involved.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A scanner apparatus comprising:
a scanner having a scanbed that is positioned to place an object to be scanned in a scan field of the scanner; and
a configurable field segmentor positioned adjacent the scanbed that demarcates a plurality of fields within the scan field.

2. The scanner apparatus of claim 1 wherein the field segmentor comprises at least one scan guide configured for placement in one of a plurality of demarcation locations adjacent the scanbed.

3. The scanner apparatus of claim 2 wherein the at least one scan guide includes a locating member and wherein the scanner apparatus further comprises a mating member in the scanner adjacent the scanbed configured to receive the locating member and position the at least one scan guide in one of the demarcation locations.

4. The scanner apparatus of claim 3 wherein the locating member comprises a channel in an end portion of the at least one scan guide and the mating member comprises an engaging member configured to mate with the channel.

5. The scanner apparatus of claim 3 wherein the mating member comprises at least one channel and the locating member comprises an end portion of the at least one scan guide configured to mate with the at least one channel.

6. The scanner apparatus of claim 5 wherein the at least one channel comprises a plurality of pairs of channels positioned in the scanner to provide at least one of the plurality of fields with a size corresponding to a common photo size.

7. The scanner apparatus of claim 6 wherein the common photo size is selected from a group consisting of 2 inches by 3 inches, 3 inches by 5 inches, 4 inches x 6 inches, 6 inches by 9 inches, 8 inches by 10 inches and 9 inches by 12 inches.

8. The scanner apparatus of claim 2 wherein the at least one scan guide has a length selected to extend across one of a length or a width of the scan field.

9. The scanner apparatus of claim 8 wherein the at least one scan guide comprises a plurality of scan guides and wherein ones of the plurality of scan guides have a length corresponding to either the width or the length of the scan field.

10. The scanner apparatus of claim 2 wherein the demarcation locations comprise at least one groove, the at least one groove being positioned in the scanner adjacent the scan field, and wherein the at least one scan guide has a length selected to extend between the at least one groove and an opposite end of the scan field and wherein the scan guide has an end portion configured to be received within the at least one groove.

11. The scanner apparatus of claim 10 wherein the demarcation locations comprise a plurality of pairs of grooves, the grooves of a pair of grooves being positioned in the housing on opposite sides of the scan field across the length of the scan field, and wherein at least one of the plurality of scan guides has a length selected to extend between a pair of grooves and wherein the at least one of the plurality of scan guides has opposite end portions configured to be received within the grooves of a pair of grooves.

12. The scanner apparatus of claim 11 wherein at least one other of the plurality of scan guides has a length selected to extend across the width of the scan field.

13. The scanner apparatus of claim 12 wherein the at least one other of the plurality of scanner guides is configured to slide along the scan field above scan guides positioned in the plurality of grooves.

14. The scanner apparatus of claim 13 wherein the plurality of pairs of grooves are positioned in the housing to provide at least one of the plurality of fields with a size corresponding to a common photo size.

15. The scanner apparatus of claim 13 wherein ones of the plurality of scan guides include a substantially straight alignment edge.

16. The scanner apparatus of claim 15 wherein ones of the plurality of scan guides include two substantially straight alignment edges each having a different associated scale.

17. The scanner apparatus of claim 2 wherein the at least one scan guide includes a substantially straight alignment edge.

18. The scanner apparatus of claim 17 wherein the at least one scan guide includes two substantially straight alignment edges each having a different associated scale.

19. The scanner apparatus of claim 2 wherein the at least one scan guide further comprises an identification marking that is positioned to be detected by the scanner when the at least one scan guide is positioned in the scan field.

20. The scanner apparatus of claim 19 wherein the scanner is configured to embed position information based on detection of the identification marking in scan data provided to a processor coupled to the scanner.

21. The scanner apparatus of claim 20 wherein the processor is configured to demarcate the scan data into separate images corresponding to ones of the plurality of fields based on the embed position information.

22. The scanner apparatus of claim 2 wherein the scanner further comprises a cover connected to a housing of the scanner and having a closed position covering the scanbed and wherein the cover includes a pocket configured to receive the at least one scan guide for storage.

23. The scanner apparatus of claim 1 wherein the field segmentor comprises at least one template configured for placement adjacent the scanbed.

24. The scanner apparatus of claim 23 wherein the at least one template includes a plurality of substantially straight alignment edges configured to align media in respective ones of the plurality of fields.

25. The scanner apparatus of claim 24 wherein the at least one template includes separation regions between ones of the plurality of fields to demarcate the scan field into a plurality of offset fields.

26. The scanner apparatus of claim 25 wherein the separation regions include a decorative border pattern positioned facing the scan bed.

27. The scanner apparatus of claim 26 wherein the decorative border pattern is at least one of a sport, holiday or birthday pattern.

28. The scanner apparatus of claim 25 wherein the at least one template comprises a plurality of templates having different associated field patterns to provide different desired shapes to the plurality of fields.

29. The scanner apparatus of claim 25 wherein the at least one template further comprises an identification marking that is positioned to be detected by the scanner when the at least one template is positioned in the scan field.

30. The scanner apparatus of claim 29 wherein the scanner is configured to embed template identification information based on detection of the identification marking in scan data provided to a processor coupled to the scanner.

31. The scanner apparatus of claim 30 further comprising the processor and wherein the processor is configured to demarcate the scan data into separate images corresponding to the plurality of fields based on the embed template identification information.

32. The scanner apparatus of claim 31 wherein the processor is configured to demarcate the scan data into separate images based on a stored template map corresponding to the embedded template identification information.

33. The scanner apparatus of claim 25 wherein the at least one template defines fields within the scan field having sizes corresponding to common photo sizes.

34. The scanner apparatus of claim 2 wherein the scanner further comprises a processor configured to detect ones of the plurality of fields based on a white space pattern in scan data.

35. A method for scanning multiple media into separate images comprising the steps of:
positioning a configurable field segmentor adjacent a scanbed of a scanner to demarcate a plurality of fields within a scan field of the scanner;
positioning media in ones of the plurality of fields; and then
scanning the scan field to provide scan data;
detecting the plurality of fields based on the scan data; and
generating separate images from the scan data for ones of the detected plurality of fields.

36. The method of claim 35 wherein the step of positioning a configurable field segmentor comprises the steps of:
selecting a template having desired fields from a plurality of different templates; and
placing the selected template adjacent the scan bed.

37. The method of claim 36 wherein the step of detecting the plurality of fields comprises detecting template identifier information in the scan data.

38. The method of claim 35 wherein the step of positioning a configurable field segmentor comprises the step of positioning at least one length demarcating scan guide at a selected demarcation location adjacent the scan bed.

39. The method of claim 38 wherein the step of positioning a configurable field segmentor further comprises the step of positioning at least one width demarcating scan guide at a selected demarcation location adjacent the scan bed, the at least one width demarcating scan guide extending substantially orthogonally to the at least one length demarcating scan guide.

40. The method of claim 39 wherein the step of detecting the plurality of fields comprises the steps of:
detecting position information indicating the selected demarcation locations of the scan guides in the scan data; and
determining the field boundaries based on the demarcation locations of the scan guides.

41. A scanner configuration device for a scanner having a scanbed that is positioned to place an object to be scanned in a scan field of the scanner, the configuration device comprising:
a configurable field segmentor configured to be positioned adjacent the scanbed and demarcate a plurality of fields within the scan field.

42. The scanner configuration device of claim 41 wherein the field segmentor comprises at least one scan guide configured for placement in one of a plurality of demarcation locations adjacent the scanbed.

43. The scanner configuration device of claim 42 wherein the at least one scan guide has a length selected to extend across one of a length or a width of the scan field.

44. The scanner configuration device of claim 43 wherein the at least one scan guide comprises a plurality of scan guides and wherein ones of the plurality of scan guides have a length corresponding to either the width or the length of the scan field.

45. The scanner configuration device of claim 42 wherein the at least one scan guide further comprises an identification marking that is positioned to be detected by the scanner when the at least one scan guide is positioned in the scan field.

46. The scanner configuration device of claim 41 wherein the field segmentor comprises at least one template configured for placement adjacent the scanbed.

47. The scanner configuration device of claim 46 wherein the at least one template includes separation regions between ones of the plurality of fields to demarcate the scan field into a plurality of offset fields and wherein the separation regions include a decorative border pattern positioned facing the scan bed.

48. The scanner configuration device of claim 46 wherein the at least one template comprises a plurality of templates having different associated field patterns to provide different desired shapes to the plurality of fields.

49. The scanner configuration device of claim 46 wherein the at least one template further comprises an identification marking that is positioned to be detected by the scanner when the at least one template is positioned in the scan field.
